(19) United States
(12) Patent Application Publication
(10) Pub. No.: US 2024/0029929 A1
(43) Pub. Date: Jan. 25, 2024

(54) METHOD AND APPARATUS FOR NOVEL HIGH-PERFORMANCE THIN FILM MAGNETIC MATERIALS

(71) Applicant: Atlas Magnetics, Reno, NV (US)

(72) Inventor: John Othniel McDonald, Reno, NV (US)

(21) Appl. No.: 18/131,350

(22) Filed: Apr. 5, 2023

Related U.S. Application Data
(60) Provisional application No. 63/327,789, filed on Apr. 5, 2022.

(51) Int. Cl. H01F 1/20; H01F 27/24; H01F 27/28

(52) U.S. Cl. CPC H01F 1/20; H01F 27/24; H01F 27/28

(57) ABSTRACT

A hybrid magnetic material comprising at least one magnetic material having at least one internal porous insulative layer; and wherein, at least one of the magnetic materials fills the voids of the internal porous insulative layer. The hybrid material blends core metals and insulation layers in a manner so that the resulting material operates as a single layer material with its own unique conductivity; skin effect; B-H curve; B_{SAT} parameters; and a unique and strong directional impedance. By using a porous insulation layer, metal layers may be bonded together through insulation layers, and this allows rapid low cost formation of the hybrid material. The hybrid material may be used to form small low-cost cores capable of handling high frequency applications.

### BACKGROUND

The general field of the present invention relates to the use of magnetic flux in electrical systems and components, and more specifically, the field of the present invention relates to the manufacture and composition of magnetic core components in such systems.

Magnetic components in electrical systems may include magnetic cores (cores). An inductor, for example, is often used with a specially designed magnetic core that lowers magnetic reluctance, thus increasing the strength of the magnetic field generated by the inductor coils, which, in turn, increases the electromotive force generated by the inductor.

A perfect magnetic core for most applications is one that has no power loss. Of course, every real magnetic core has power loss. A core will lose power for two primary reasons: Hysteresis core loss and Eddy current core loss.

Hysteresis core loss has to do with how easily the magnetic material can switch back and forth between magnetizing states as the magnetic flux changes. We refer to this ease or difficulty in switching as coercivity. Every magnetic material has a different coercivity. Generally, the metallic soft magnetic materials used in this process have low coercivity, and therefore the core losses due to coercivity are usually not significant, which is not always the case with competitive ferrite-based soft magnetic materials. However, core losses due to eddy currents are far worse for metallic magnetic materials versus ferrites due to very low resistivity.

Hysteresis loss per unit volume, also known as specific loss, P_{m,sp} can be approximated by

P_{m,sp}=kf^{a}(B_{ac})^{d} (1)

Where k, a and d are constants that vary from one material to another and f is the frequency in Hertz. B_{ac} is the peak value of the magnetic induction flux density, also depending on the time average of it. As an example, for the commonly used ferrite material known as 3F3 relation (1) is explicitly given as,

P_{m,sp}=1.5×10⁻⁶f^{1.3}(B_{ac})^{2.5} (2)

Where P_{m,sp}, f and B_{ac} are in mW/cm³, kHz, mT (mili Tesla).

Time-varying magnetic flux in a conductor will generate an electric motive force (emf), a phenomenon also known as electromagnetic induction, which in turn will produce time-varying current related to the resistivity of the material according to Faraday's law. These currents are known as eddy currents.

Assume a thin rectangular lamination having a width, length, and thickness of, w, L, d respectively. Moreover, assume the thickness d, is less than the skin depth δ given as

$$d < δ where δ = \sqrt{\frac{2}{ωμσ}} \qquad ( 3 )$$

Where ω, μ and σ are angular frequency, magnetic permeability, and conductivity of the lamination. Assuming the magnetic induction in the lamination is uniform and has a sinusoidal time dependence given as

B(t)=Bₘₐₓ Cos(ωt) where ω=2πf (4)

Where Bₘₐₓ is the peak magnetic induction in the lamination and f is the frequency in Hertz (Hz). For these assumptions, the eddy current power generated in the total lamination volume P_{ec} can be closely approximated as

$${P}_{ec} = \frac{{wLd}^{3} {ω}^{2} {B}_{max}^{2}}{24 {ρ}_{core}} \qquad ( 5 )$$

Where ρ_{core} is the resistivity of the lamination. The specific eddy current loss P_{ec,sp}, which is loss per unit volume, becomes

$${P}_{ec , sp} = \frac{{d}^{2} {7}^{2} {B}_{max}^{2}}{24 {ρ}_{core}} \qquad ( 6 )$$

As can be seen in equation (4) eddy current loss is exponentially related to lamination thickness and inversely proportional to the resistivity!

Metallic magnetic materials, despite far superior magnetic performance for most parameters than ferrites such as higher B_{SAT}, higher permeability, higher curie temperature, and lower coercivity, also have such a low impedance that the eddy current generation is so great and thus core losses so high that that metallic magnetic material use is often precluded in many core applications.

Ferrite materials have up to 10¹³ orders of magnitude higher resistivity (ρ_{core}) vs. metallic metals resulting in low core losses and, thus, more power-efficient circuits. However, due to the low B_{SAT} of ferrites (0.3 to 0.5T) much more ferrite material is required to avoid magnetic flux saturation. The resulting electronic components based on ferrite cores are often so large as to be the limiting factor in the overall thickness and size of consumer end products, for example, smartphones or tablets. Therefore, the electronic industry has put continuous research and development efforts in developing higher B_{SAT} ferrites or increasing the resistivity of metallic magnetics to make use of their higher B_{SAT} (0.8 to 2.4T) without the resulting high core power losses.

The most common solution to raising the resistivity of the metallic magnetic material is to turn the magnetic material into a powder with an oxidized high resistivity surface whereupon the powder is compressed at high pressures to form the core shape. The resulting core is known as a powder core. By altering the powder particle size and the oxidized surface, various commercially viable electronic components can be realized. This process, however, is not compatible with direct integration onto a silicon wafer or packaging substrate, which cannot withstand the pressures or heat associated with the powder process and usually results in a substantial drop in relative permeability.

Another common solution to raise the resistivity of a metallic magnetic core is to layer the material such that electrical insulating layers are placed periodically within the metallic magnetic core and in parallel with the direction of the flux. The insulation layers are intended to have very high resistivity (>1 Megaohm) and offer DC electrical isolation from one layer to the next. Because eddy currents run perpendicular to magnetic flux lines, the parallel-to-flux electrical insulation blocks the eddy currents but not the magnetic flux lines. The relative permeability of layering will be much higher as compared to metallic magnetic powders, provided that at least a portion of the magnetic layers are deposited relatively evenly.

The layering thickness is determined by the desired frequency of operation, with thinner layers being required for higher frequencies. Some layering techniques are compatible with silicon wafer processing and semiconductor packaging processes allowing for physically close integration of the magnetics and associated silicon-based circuits. The close integration of magnetics with the associated silicon circuits also conveys the added benefits of reduced interconnection distances and the ability to tune silicon and magnetic components together for the highest performance.

However, the nature of eddy currents changes as the frequency of the current increases. A low-frequency current will generate less intense but more widely circling eddy currents. A high-frequency current will generate more intense eddy currents but in a more concentrated area than a low-frequency current. Thus, not only does a higher-frequency current have more intense eddy currents such that it needs more insulation than an eddy current from a low-frequency current, but it also will have fewer insulation layers in its pathway to reduce the eddy current. An eddy current from a high-frequency current might fit in between the insulation layers, which would reduce the eddy currents from a low-frequency current.

Creating thinly layered laminated cores is a complex process that has limited the thickness, layer count, and cost of the small laminated cores. One traditional layering process would involve the following steps: electroless copper (e′less) surface preparation, electroless deposition of very thin copper, cleaning, dry film patterning, electrodeposition of magnetic material, dry film removal, cleaning, etching to remove the electroless copper, cleaning, dry film patterning, copper coil electroplating, placement of insulation, grinding, insulation surface preparation, and repeat back to the e′less copper surface preparation step in a 14-step process. Therefore, laminated cores take significantly longer to create than pure single-material cores, which involve a single patterning step and a single plating step.

In making a laminated core in the microelectronics industry, each layer is plated according to a pattern, typically a dry film pattern, which acts like a stencil, which must be recreated and replaced for each layer. This causes misalignment over multiple layers as it is nearly impossible to perfectly align the patterns for each layer on the nanometer scale. The resulting core layers will each be offset from each other to some degree. This causes reliability issues, and as such, the number of layers that can be placed in a laminated core is limited by the manufacturing processes. Manufacturing tolerances not only limit the layer count, but they also limit the thickness of the layers of the core and, thus, the minimum size of the cores.

To date, no laminated magnetic cores have not had a significant commercial impact with small high-frequency applications for four reasons:
i) The process of layering is expensive.
ii) Due to layering being expensive, less magnetic core material is used, resulting in very low-value inductors (often sub 50 nH) that require very high switching frequencies (30 MHz to 100 MHz) to convert a meaningful amount of power. These high switching frequencies require small geometry semiconductor process nodes, which in turn severely limit the voltage range of the power converter, and thus the end applications become quite limited as well.
iii) Metallic magnetics, which, even though only 10 um thin, are still thick by silicon process standards and have different temperature coefficients than materials commonly used in the semiconductor process—which can generate reliability issues due to cracking as one material expands at a rate different than a material next to it.
iv) Magnetic cores are usually made from Ni, Fe, Co, or various alloys of these materials, some of which are banned from very costly semiconductor fabs, and as such, the magnetic material must be post-processed in a separate isolated line, further raising the cost.

Therefore, there is still a need to provide a small magnetic core that no longer is the size limiter of passive magnetic components even in high-frequency applications of the microelectronics industry, which works in both low-frequency and high-frequency current applications. Such a core would be optimal if it could be created without the omnidirectional impedance of powder cores and also overcome the manufacturing limitations of the laminated core while being comparable to pure single-material cores in manufacturing time and cost.

The following United States patents and patent applications are incorporated by reference in full:
U.S. Ser. No. 10/532,402 B2, System and method for making a structured magnetic material with integrated particle insulation, invented by Hosek Martin and Sah Sripati
US 2021/0005378 A1, Magnetic Element, Manufacturing Method of Magnetic Element, and Power Module, invented by Hong Shouyu, Zhou Ganyu, Fu Zhiheng, Tong Yan, Chen Qingdong, Xin Xiaoni, Zhou Jinping, Ji Pengkai, and Ye Yiqing
US 2018/0215960 A1, Solid Insulation Material, invented by Huber Jurgen, Schirm Dieter, and Übler Matthias
U.S. Pat. No. 4,204,087 A, Adhesive coated electrical conductors invented by Lin Kou C, and Woods Edmund E
U.S. Pat. No. 7,670,653 B2 Coating method for an end winding of an electric machine invented by Kaufhold Martin, and Klaussner Bernhard

The following foreign patent applications and patents are incorporated by reference in full
GB 799250 A, Improvements relating to laminated cores for electrical apparatus, filed by general electric
WO 2016/171689 A1, Electrical Device With Electrically Enhanced Insulation Having Nano Particulate Filler, invented by Hondred Pete, Holzmueller Jason, and Manke Gregory Howard

### BRIEF SUMMARY

The material of the present invention is a hybrid material, the hybrid material may be referred to as hybrid magnetic mass, and when shaped into a core the hybrid magnetic mass is referred to as a hybrid core. The material is referred to as a hybrid because it blends core metals and insulation layers in a manner so that the resulting material operates as a single layer material with its own unique conductivity, skin effect, B-H curve, B_{SAT} parameters, and a unique and strong directional impedance.

These properties are granted through the use of porous insulation layers. A porous insulation layer of the present invention allows for direct plating through the insulation layer so, for example, the underlying metallic layer may act as an electrode in an electroplating process. However, the insulative layer still retains an insulative effect that is strong enough to reduce power losses created by high-frequency current enough to allow for small, efficient, and high-frequency capable cores.

By layering, preparing a layer of magnetic material; forming a porous insulation layer onto a surface of the layer of magnetic material; and depositing an additional layer of magnetic material onto a surface of the insulation layer in a manner connecting the additional layer of magnetic material to the prepared magnetic material through the porous insulative layer.

However, a hybrid material can be created without the deposition of an additional layer of magnetic material. This will create a magnetic material having a porous insulative layer on an external surface of the magnetic material and the magnetic material will be capable of serving as an electrode in a plating bath.

To build up the hybrid material, perform and repeat at least once the steps of depositing an additional layer of porous insulation layer onto a surface of the additional layer of magnetic material and depositing at least one further layer of magnetic material onto the additional layer of porous insulation layer until or before the earliest of 60 core layers or 50 μm total magnetic material thickness is reached. However, it is not necessary to plate a single metal layer and then plate a porous insulation layer. Instead, one may plate multiple magnetic layers before depositing a porous insulation layer. Therefore, a hybrid magnetic material comprising, at least one magnetic material having at least one internal porous insulative layer; and wherein, at least one of the magnetic materials filling through the voids of the internal porous insulative layer, is achieved.

The hybrid magnetic material has a primary magnetic material composition incorporating nickel, iron, cobalt, or an alloy thereof and may further have a composition incorporating a core additive. Common additives include chromium, magnesium, aluminum, phosphorus, carbon, or sulfur—a core additive is a material that is added to a core to improve or add to a property of the core. Additives can be mixed into the core layers or have their own layers in the material.

The hybrid material may have multiple layers of metal between each porous insulative layer. The material which is used to fill the voids of the porous insulation layer may have its own layer which is equal to and superimposed with the porous insulation layer. The material filling the voids of the porous insulative layer may be a core additive.

To deposit the magnetic material layers, an electroplating method may be used. The electroplating method is a direct current plating, pulse plating, reverse pulse plating technique or a combination of these techniques. A useful combination of techniques is direct current plating followed by a pulse or a reverse pulse plating technique starting with pulse plating may remove some of the porous insulative layer.

There is no need for any surface preparation of the insulative material or other intermediary steps between the deposition of the magnetic material and the porous insulation; however, washing and drying the material layer before plating the additional porous insulation layers can be beneficial.

To deposit the porous insulation, layer a printing method, a AP-PECVD deposition, or a combustion chemical vapor deposition process may be used. To form a porous insulation layer after depositing a non-porous insulation layer a process such as grinding or etching may be used to thin the layer until it becomes porous.

Both AP-PECVD deposition, CCVD, and in some cases printing rely on chemical precursors to produce the insulation material for the porous insulation layer. When the porous insulation layer is a porous silicon dioxide insulation layer, the chemical precursor will be a silicon dioxide precursor. Polysiloxane is a class of chemicals that can be as a precursor to silicon dioxide.

When depositing a porous insulation layer by AP-PECVD or CCVD the patterning elements, for example, photoresist or dry film, may be coated by flame or AP-PECVD. The photoresist or dry film may be passed through the deposition flame or plasma at a rate exceeding 1 meter per minute and may be passed through the deposition flame or plasma at a distance closer than 20 cm from the source. In at least one exemplary embodiment, after all deposition steps are completed the patterning elements may be removed, for example, by standard chemical stripping.

In at least one exemplary embodiment, the porous insulative layer is deposited with a deposition method that is designed to thin the deposited material to such an extent as to introduce the necessary voids necessary to immediately begin electroplating following the insulative deposition. These are the mechanical or chemical etching methods of forming a permeable insulative layer. An insulative layer may be placed, and then, for example, ground down by a grinding process until the insulation layer is so thin that voids begin to appear. In some embodiments, only certain portions of the insulation layer will be thinned or turned into voids. These post-insulation deposition processes may be designed to introduce a regular or random pattern of voids in the porous insulation layer.

By requiring only a single patterning step, an ability achieved by allowing the patterning element to pass under or through plasma or CCVD flame and plating through the porous insulative layer, the hybrid magnetic material will have side walls that does not have an offset portion as the patterning elements, for example, dry film or photo resist need not be replaced. Therefore in at least one embodiment, the photoresist or dry film is not replaced or removed during the plating process, and the insulation deposition occurs for up to 60 electroplated magnetic layers. When this occurs, the insulative material may deposit on the patterning elements as well as the magnetic layers.

In at least one exemplary embodiment, the insulation layer has a coverage percentage between 90 and 99.99% and has a thickness of between 10 nm and 5 μm. Although the insulation layer thickness in other embodiments may be under 4 μm, for example, when a AP-PECVD deposition process is used. In other embodiments, the layer thickness may vary and may be any thickness or range of thicknesses.

In at least one exemplary embodiment, the porosity of the porous insulative layer is defined by a series of voids in the insulation layer, with each of the voids individually smaller than 22 μm in diameter. In other embodiments, the voids may vary in size, and larger voids may be created. The larger voids may even occur due to the random nature of some deposition processes, including AP-PECVD or CCVD. The pattern of voids may be regular or random.

The hybrid magnetic material may be operably connected to a base. This connection is achieved by depositing the material on the base. In at least one exemplary embodiment, the base may be a semiconductor wafer, silicon-on-insulator wafer, semiconductor substrate, panel, sheet, roll, or carrier up to 50 μm thick. In at least one embodiment, the base has a series of ridges of squared, circular, or triangular shapes with a localized roughness of less than Sum. The roughness increases the surface area of the upper surface of the hybrid material. More than one hybrid material may be plated on a single base if the base is large enough.

Depositing the hybrid material in the shape of a magnetic core with enough insulative layers will configure the hybrid material to serve as a hybrid core. In theory, at least one insulative layer is enough for the hybrid material to serve as core; the number of insulative layers may be optimized according to the intended use of the core.

When the hybrid material is configured as a hybrid core, a metallic coil is operably placed around the hybrid magnetic material, and this will convert the hybrid material to a hybrid core.

When there is at least one additional hybrid magnetic material operably configured as a magnetic core, and a metallic coil operably placed between the first hybrid magnetic material and the second hybrid magnetic material, the two hybrid materials become hybrid cores.

The hybrid material may be configured as a core and integrated into a stack of cores, each of the cores in the stack of cores is operably separated by an insulative layer. In at least one exemplary embodiment, the stack of cores has a total thickness of less than or equal to four millimeters. In at least one exemplary embodiment, the insulative layer between each core of the stack of cores has greater than ten times the resistivity of the porous insulation layers within each hybrid material.

In at least one embodiment, the stack of cores is shaped and operable as a single magnetic core, and in at least one embodiment a metallic coil operably is operably placed around the stack of cores configured as a single magnetic core. In at least one exemplary embodiment, there is a second stack of magnetic material, integrating at least one hybrid magnetic material configured as a core, operable as a single magnetic core, operably connected to a base shared with the first stack of cores, and a metallic coil placed between the first stack of magnetic material and the second stack of magnetic material. A metallic coil may be placed between two stacked magnetic materials or around the stacks of magnetic material.

### BRIEF DESCRIPTION OF THE FIGURES

FIG. 1 is a cross-sectional view of a hybrid material with a single porous particulate insulation layer.

FIG. 2 is a top-down view of a porous insulation layer having a uniform void distribution.

FIG. 3 is a top-down view of a porous insulation layer having a random void distribution.

FIG. 4 is a perspective view of a CCVD combustion chamber.

FIG. 5 is a perspective view of combustion originating in a CCVD combustion chamber.

FIG. 6 is a representation of a vapor product expelled from a CCVD combustion chamber.

FIG. 7 is a perspective view of a possible orientation of the combustion chamber and a deposition recipient where the chamber is directly above the recipient.

FIG. 8 is a perspective view of a possible orientation of the combustion chamber and a deposition recipient where the chamber is to the side of the recipient.

FIG. 9 is a perspective view of a possible orientation of the combustion chamber and a deposition recipient where the chamber is at an angle in regards to the recipient.

FIG. 10 Is a perspective view of a combustion chamber and a large recipient.

FIG. 11 Is a perspective view of the combustion chamber and a recipient showing that the recipient may rotate or tilt.

FIG. 12 Is a perspective view of the combustion chamber and a recipient showing that the combustion chamber may be used to deposit on two recipients at once.

FIG. 13 Is a perspective view of the combustion chamber and a recipient showing that the combustion chamber may rotate to move between depositing on recipients.

FIG. 14 Is a perspective view of two combustion chambers and one recipient showing more than one combustion chamber may be used on a single recipient.

FIG. 15 Is a perspective view of two combustion chambers and one recipient showing more than one combustion chamber may be used on a single recipient to deposit on multiple sides of a recipient at once.

FIG. 16 is a side view of a particulate form of porous insulation layer deposited on a recipient.

FIG. 17 is a close-up view of a hybrid material having two thin, porous insulation layers with offset voids.

FIG. 18 is a close-up view of an irregularly shaped void showing that a current would have to curve to avoid the insulation.

FIG. 19 is a perspective view of a single eddy current pathway traveling through three layers of porous insulation.

FIG. 20 is two cutaway views of a single porous insulation layer of the hybrid material with one cutaway showing un-impeded pathways and one cutaway showing impeded pathways.

FIG. 21 is a cross-section of a hybrid material with multiple magnetic core materials vertically arranged.

FIG. 22 is a cross-section of a hybrid material with multiple magnetic core materials horizontally arranged.

FIG. 23 is a side view of a laminated magnetic core, not of the present invention, having offsets along the side wall.

FIG. 24 is a hybrid material of the present invention without offsets.

FIG. 25 is a flow chart of the method for forming a hybrid material.

FIG. 26 is a flowchart showing cross-sections of each step of the hybrid material formation in the process of configuring a hybrid core.

FIG. 27 is a side view of a stack of cores incorporating at least one hybrid core and having a strong insulation layer between each hybrid cores.

FIG. 28 is a graph of inductance over frequency for hybrid cores of the present invention.

FIG. 29 is a graph of Q over frequency for hybrid cores of the present invention.

### DETAILED DESCRIPTION OF THE INVENTION

The present invention relates to the field of thin film magnetic material and material science. Without limiting the indication, the present invention is directed toward novel magnetic materials and the methods of producing such magnetic materials.

The methods of the present invention present methods of manufacture that result in a high-frequency, high-performance thin film magnetic material for use in but not limited to, transformers and inductors as magnetic cores; inductive filters; and inductive-based sensors to be generated in a low-cost manner by creating a “hybrid magnetic material” of periodically layered magnetic metals and novel porous insulation that is mechanically, chemically, electrically, and thermally compatible with traditional semiconductor packaging, semiconductor wafers and other materials including but not limited to dry film and photoresist used in the manufacturing process of the same. The present invention thus greatly expands the use and application of thin film magnetic materials for use in integrated magnetics on silicon wafers and in semiconductor packages where the close proximity to the associated electronic circuits offers numerous performance advantages.

The new methods create a new “hybrid magnetic material” with unique properties which will be referred to as “hybrid magnetic material”. Traditional magnetic materials which are able to be electroplated, such as Co, Ni, Fe, and their alloys, not including insulation materials, will be referred to as “magnetic materials.” Electrical insulative materials will be referred to as “insulative materials.” The hybrid magnetic material combines magnetic materials and insulative materials in a manner that allows for a new single material to be made which has directional impedance. Magnetic cores used in transformers or inductors of the present invention will be referred to as “hybrid cores” as an example of an application-specific term.

The porosity, pinholes, or intentionally created gaps within the insulation layers of the hybrid material allow magnetic materials to fill the voids in the insulation layers during the electroplating deposition of the subsequent magnetic material layer and thus form a single mass of hybrid magnetic material. For example, in electroplating, the initial layer of magnetic material can still act as one of the two electrode plating electrodes, even through an insulative layer of the present invention—because the insulation layer is porous.

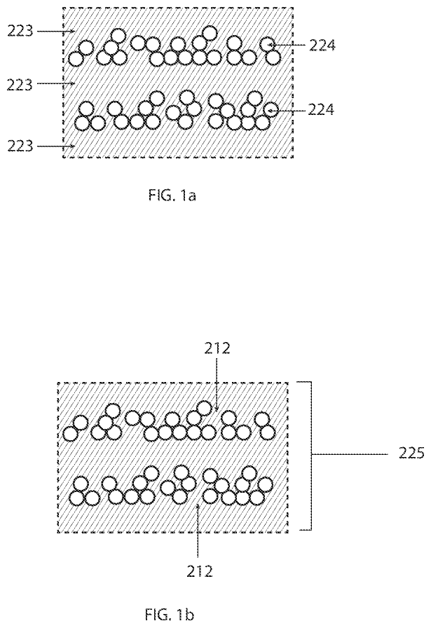

Although any subsequent layer deposited onto a porous insulation layer will combine with the recipient metal layer (recipient) to form a new, essentially single layer of material that has a porous insulation layer within it, it can be useful in describing the material to define the layers individually. FIG. 1a shows magnetic material layers 223 and porous insulation layers 224; these layers have been individually defined to enable us to speak of placing a layer down or forming a layer of material. However, FIG. 1B shows that a recipient 223 will form what is a single block of material 225 with porous layers of insulation 224 by connecting through the through-holes (voids) of porous layers 224 (for example, voids 212). The layers 223 may vary in thickness or composition as may layers 224.

As the metals and the insulators of the preferred embodiments are widely available, the material cost of the present invention is low. As direct electroplating requires only a few steps, the magnetic material of the invention is cheap and quick to form—in exemplary embodiments, the cost is far lower than thin film magnetic materials where the insulation layer impedance prevents the next layer from being directly electroplated or alternatively as compared to traditional closed chamber plasma vapor deposition “PVD” or “CVD” processes commonly used in the semiconductor industry which is far slower, more expensive and requires each layer to have a new photoresist pattern.

As noted above, the insulation layer of the present invention allows the magnetic material to fill the voids in the insulation layer so that each layer of magnetic material may physically and electrically connect through the insulation layer. Thus the insulation layer is a porous boundary layer within the core, and this porosity is by intention. The ability for the magnetic metal layer to connect electrically allows for the magnetic material layer to function as an electrode in a plating process. However, to most trained in the art, the intentional electrical connection of metal layers in a core would immediately seem to defeat the purpose of requiring insulation layers in the first place and indeed it does limit the performance somewhat between two layers, but the cost reduction of placing each layer thus economically allowing for far more layers and thinner layers results in higher performance for the entire hybrid magnetic material for key specifications and at least sufficient performance for all other parameters.

Thus, the downsides of the thin porous insulation layer are mitigated by presenting a series of porous insulation layers within the novel magnetic material as each new porous layer better enables the magnetic material to increase its resistance to eddy currents. Upsides of the thin, porous insulation layer are that it is a thin insulation layer that is simple to place and multiple insulation layers can be placed closely together the layer count of a hybrid material is limited by the eventual build of resistance in the hybrid material so that it no longer serves as an electrode.

The porous insulation layer can be economically placed hundreds of times within the magnetic material before the magnetic material reaches a thickness where the material impedance is too high to economically allow further plating. However, in the exemplary embodiments, this thickness limitation approaches 50 μm which is far thicker than the economic or manufacturing limitations of existing layering technologies.

State of the art thin film laminated metallic magnetic materials for integration on silicon wafers or semiconductor packaging of similar performance take a lot of time and expense to produce, requiring a significantly elevated number of processing steps and wasted processing materials limiting their application. The present invention provides a less expensive, faster, more scalable, and less material and energy-wasting method by which thin film laminated magnetic materials can be realized. Developing for the first time a cost-effective process that only requires zero to very little surface preparation for each new layer other than washing and drying after the magnetic electroplating. And if in a patterned application, then only a single dry film or photoresist for up to 60 layers in this exemplary patterned embodiment instead a new dry film or photoresist and the numerous preparation steps associated with each layer in the existing state of the art thin film magnetic materials.

In general, the methods of producing the hybrid material integrate well with methods of producing integrated magnetic cores directly on silicon wafers or semiconductor packaging in either a patterned additive process or a subtractive process as the process is mechanically, thermally, electrically, chemically compatible.

The use of certain high magnetic flux saturation, B_{SAT}, metallic metals produced from Cobalt, Nickel, and Iron and their alloys often containing lesser quantities of other atoms is well known in the industry. These metallic metals when electroplated into a hybrid core also convey the same or similar high B_{SAT} even though their low resistivity results in comparatively high eddy currents. A higher B_{SAT} results in a thinner magnetic hybrid core having the same amperage rating or a magnetic hybrid core of similar thickness having a higher amperage rating. The use of silicon dioxide and similar insulative materials, for the porous insulation layers, ensures that the eddy currents are sufficiently impeded.

To form a hybrid core of the present invention, a metallic layer is first prepared by electroplating, the surface is washed and dried, then a porous insulation layer is formed by CCVD or AP-PECVD, next an additional metal layer is deposited. In the exemplary embodiment, the insulation layer may be composed of insulative particles stuck together in such a fashion as to leave a small percentage of voids. In another embodiment, the insulation layer may also be a very thin plasma-enhanced deposited material such that pinholes are randomly distributed across the surface of the insulative layer. In yet another embodiment, the insulation layer may be deposited void free but have voids that are generated by additive, subtractive, or mechanical processes. Additive processes include printing processes, subtractive processes include drilling or etching, and mechanical processes include crushing or thinning. In all cases, voids in the insulation layer are generated, which may be arranged randomly, systematically, or at least semi-randomly. A semi-random process is a random process that is directed on some level, for example, directing a random process to some limited portion of the insulative layer or setting a minimum distance for individual voids.

In at least one exemplary embodiment, the magnetic material is prepared or deposited in layers that in total are less than 50 μm thick onto a base which may be but is not limited to, a semiconductor wafer, silicon-on-insulator wafer, semiconductor substrate, panel, sheet, roll or carrier. In at least one embodiment, the base to be electroplated is designed to increase the total surface area of the final magnetic layer for the purpose of increasing the total volume of magnetic material by having regular or irregular ridges of squares or rectangles, semi-circular or semi-elliptical shapes, or triangular shapes of a 1.5 to 5× aspect ratio. In either case, the flat or shaped base presents a localized roughness of less than 5 μm with the ideal being 0 μm. As layers are deposited onto the base, the layer surfaces will roughly reflect the underlying surface of the base.

The porous insulation layer is an insulation layer that is intended to be physically and electrically porous enough such that a metal layer beneath the insulation layer can be used as an electrode in an electroplating bath or as a base for a subsequent metal layer in at least one other deposition process. In at least exemplary embodiment, the through-portion of the porous insulation layer will leave between ninety-five and ninety-eight percent of the underlying layer surface still covered. However, in other embodiments, coverage percentages between eighty percent and very near one hundred percent are economically viable. The insulation layer may be deposited in one or more depositions to achieve the desired coverage percentage as determined through empirical characterization of the process using industry-standard tools or indirectly by measuring the frequency response of the resultant magnetic material.

To achieve a porous insulation layer, several techniques may be used. In one exemplary embodiment, the porous insulation layer is produced by combustion chemical vapor deposition “CCVD” using a silicon dioxide precursor chemical injected into a flame. In at least one exemplary embodiment, the porous insulation layer is produced by open air atmospheric pressure plasma enhanced chemical vapor deposition “AP-PECVD”. In yet another exemplary embodiment, the porous insulation layer is produced by a print process. However, there are many suboptimal ways to provide a porous layer, such as intentionally crushing, pattern etching, or exposing to radiation the insulation or thinning, grinding, or polishing a deposited layer to achieve a sufficient number of voids to allow for continued electroplating. A suboptimal porous insulation layer can mean that a process only takes advantage of a portion of the novel features described in this invention but may still be economically viable.

In Combustion Chemical Vapor Deposition “CCVD,” or open-air plasma-enhanced vapor deposition, and printing methods, once the porous insulation layer is placed, without any intermediary steps, the magnetic material and the most recent porous insulation layer may be placed directly into an electroplating bath, and the subsequent magnetic layer magnetic material electroplated. The magnetic material being plated will fill the voids of the porous insulation layer and form a new magnetic layer that is connected to the previous magnetic layer so that they effectively become one. The voids in the insulation layer no matter their deposition method are ideally of a size smaller than the thickness of an individual layer which in the preferred embodiment are 1.5 μm or less but in all cases have a plurality of void sizes of 25 μm. Due to the random and statistical nature of the size and location of the voids in many of the deposition methods, there will be cases where statistically a larger-than-desired void is created. However, finer layering and careful characterization of the deposition process with sufficient statistical process tolerance can mitigate any yield issues. This coupled with a final frequency and load tests result in a high quality, high performance magnetic material suitable for use in inductors, transformers and other magnetically enabled electronic components.

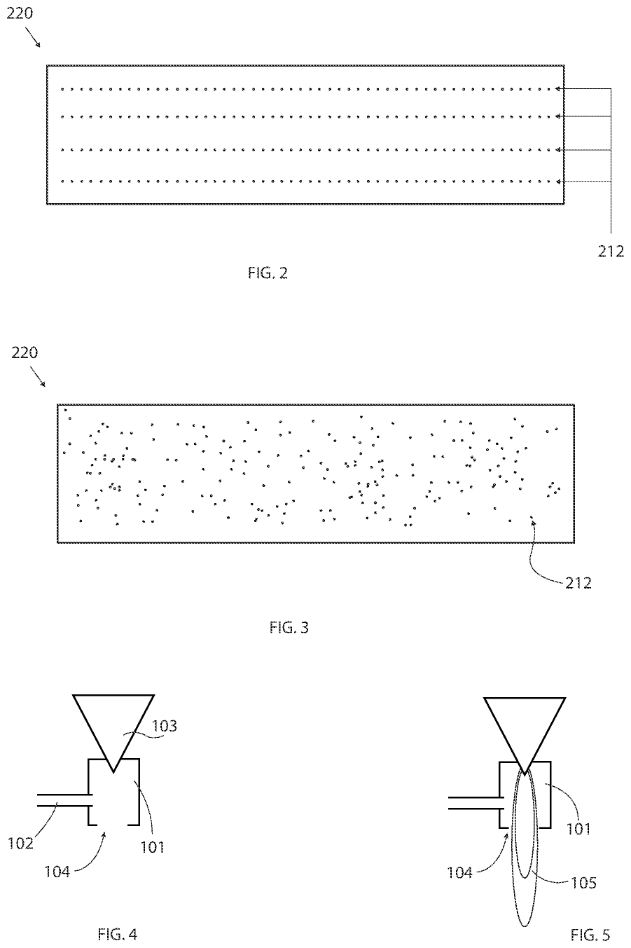

In the case of printed insulation, the voids 212 may be placed as desired for example as shown in FIG. 2 where voids 212 are uniformly spaced. The arraignment of voids 212 may be randomly generated, shown in FIG. 3 where there is a random generation of pinhole voids. Printing provides good control over the placement of the voids in the insulation layer, but is currently a slower and less uniformly porous process as compared to CCVD or AP-PECVD.

In open air atmospheric pressure plasma-enhanced chemical vapor deposition “AP-PECVD”, a chemical precursor gas or a mix of precursor gasses are put into a plasma state and the resulting reaction produces a ionized vapor of the intended insulator which is then used to deposit the material by charge-based attraction. The deposition of the vapor molecules is random. AP-PECVD deposition may be used to create a thin porous particulate layer of insulation where the adjustment of the thinnest of the material creates more or less voids. An AP-PECVD process with a polysiloxane precursor can be used alone or in combination with other deposition processes such as the CCVD process both simultaneously or on a different layer to impart a higher layer impedance as compared to CCVD deposited SiO2 alone.

In CCVD, a burner will initiate a chemical combustion reaction by flame which is usually the combustion of propane or butane with oxygen. A precursor chemical is then injected into the flame where it reacts to form an insulator such as SiO2. The molecular scale SiO2 exiting the flame is very hot and quickly combines with other SiO2 molecules to form larger hot SiO2 clumps which fall as a type of snow on the deposition surface. The hot SiO2 clumps then adhere well to the magnetic metal surface and to each other to form a porous SiO2 material. The speed at which the deposition surface passes under the combustion flame and the distance the surface is from the flame will determine the consistency and thickness of the coating as well as the temperature compatibility with patterning dry film or photoresist. More than one CCVD precursor chemical can be used as a mixture or in series to form complex oxides for various performance reasons.

At the time of writing, only products such as oxides of the transition metals: zinc, zirconium, titanium, silver, tungsten, and molybdenum; post-transition metals: tin, aluminum; and metalloid: silicon are known to be practical and useful to form by CCVD. Of these elements, silicon produces a high impedance porous oxide that is advantageous for its cost, environmental, electrical, thermal, mechanical and lack of magnetic properties by forming silicon dioxide in a combustion reaction. This may change as new and better precursors are developed. Insulative precursor chemicals are chosen on the basis of cost, coverage percentage, overall electrical or mechanical performance of the insulative material or any combination of these characteristics and may be a mix of chemicals.

Combustion reactions grant a silicon atom two oxygen atoms to become silicon dioxide (SiO2). However, in practice, it is not pure silicon that is combusted, instead, there are a variety of silicon dioxide precursors and oxidants that may be used to arrive at SiO₂ via a combustion reaction, including but not limited to polysiloxanes. One SiO₂ precursor suitable for electroplating is trademarked Pyrosil and allows for the SiO₂ to be formed at low-cost and deposited quickly enough to avoid dry film thermal damage when the proper flame range and magnetic surface velocity is used.

In general, multiple precursors may be used to form a porous insulation layer and in such cases the insulative precursor materials may be premixed and deposited in the same flame, plasma, or ink, or co-deposited in separate flames, plasmas or inks, or separately deposited at different times.

CCVD parameters for depositing an insulative core layer include the airflow to the flame, the rate of fuel available and the rate of the chemical precursor being fed into the flame resulting in a bluish orange tinted uniform. Prior to the injection of the chemical precursor the flame should appear as any proper propane, natural gas, or butane “blue” flame. A typical efficient flame and a large number of uniformly placed burner heads of openings is required for consistent uniform deposition of the insulative material.

Referring to CCVD as demonstrative of the control of these principles, FIG. 4 shows a possible burner head for use in CCVD. The burner head has an open chamber 101 which contains the oxidant. A nozzle 102 is connected to chamber 101 and this nozzle 102 injects the precursor into chamber 101. At the base of chamber 101 is a burner 103. Burner 103 utilizes a secondary combustion reaction to generate a flame that will heat the precursor as it enters chamber 101 and the oxidant that is in chamber 101 to drive their combustion. The product will exit the chamber through hole 104.

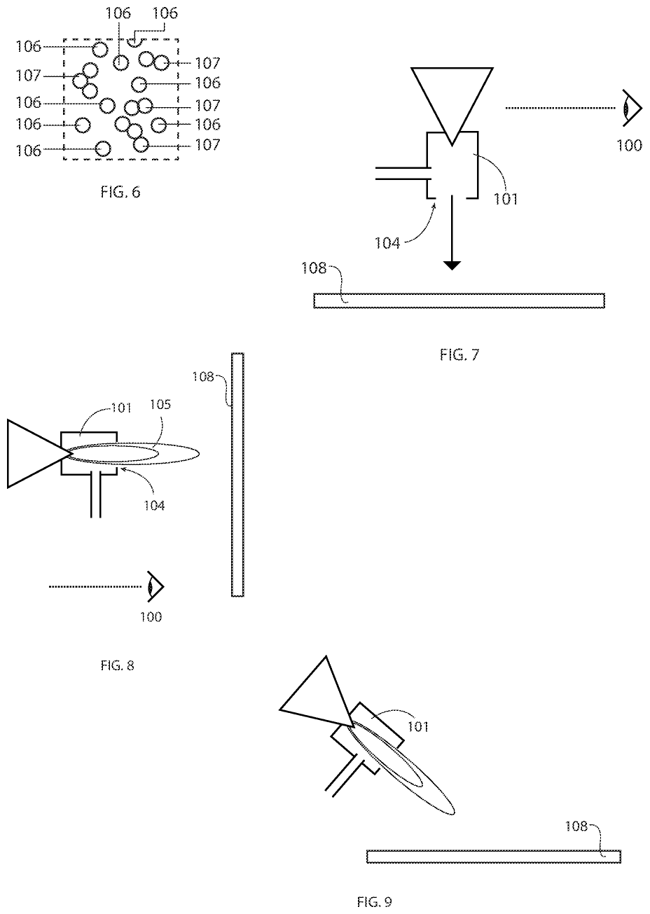

As shown in FIG. 5 flame 105 of the reaction may exit chamber 101. Thus, not all of the reaction necessarily will occur in the chamber as flame 105 will generate a force that pushes out some of the reactants through hole 104. However, given the heat, most of the reaction will occur in chamber 101 and it will be the products that are pushed out of chamber 101 by the combustion 105.
a. As the SiO2 molecules are ejected from the combustion chamber, they may collide with each other and fuse to form clumps of molecules. Thus, there will be a collection of individual reactant product molecules as well as clumps of products leaving the combustion chamber. These individual molecules and clumps may be called particulates. FIG. 6 shows a mixture of individual molecules 106 and molecule clumps 107 after being ejected from a combustion chamber. There are a myriad of possible interactions among the molecules and the actual set of interactions occurs chaotically. The molecules, including clumps, are in motion and may continue to collide as they fall. Molecules may land on each other on the recipient and bond with each other.

Typically, these clumps will be under a nanometer in size. In the case of SiO₂, depending on the arraignment of molecules and the form of SiO₂ it may take as little as two SiO2 molecules to come together to form a 1 nanometer-long clump. The products of the CCVD reaction are atomic and thus the produced layers are measurable on the nanoscale. The clumps are on average less than ten nanometers across, but the size may be adjusted by adjusting the parameters of CCVD.

The products of the reaction will generally leave the combustion chamber, being ejected primarily by the combustion of gas towards a recipient surface. Given the molecular interactions that occur as the product moves between a combustion chamber and a recipient, the product will be deposited onto the recipient in a statistical bell curve manner with the highest deposition rate being directly under the flame, thus a large number of burner heads or burner openings and sufficient distance from where the combustion occurs to the recipient surface are required for uniform deposition.

The longer the SiO2 particles are accelerated onto the recipient surface the more the porous insulation will cover the recipient. Thus, the combustion chamber 101 may be held in a location over recipient 108 as shown in FIG. 7. In FIG. 7 and FIG. 8, eye 100 represents the eye of a standing person and is used for a directional reference. The combustion chamber 101 and the recipient 108 may be closer than twenty centimeters even if the combustion flame touches the recipient, and in AP-PECVD deposition the recipient may be closer than twenty centimeters to the plasma as well.

The combustion chamber 101 may be in any location around recipient 108. For example, a combustion chamber 101 ejects by combustion 105 through hole 104 particulates to a recipient 108 placed to the side of combustion chamber 108 as shown in FIG. 8. This is useful if the recipient is hung on a chain in the style of an assembly line or is to be dipped into an electroplating bath.

The angle of both the recipient and the burner may be any angle suitable for creating a hybrid material. FIG. 9 shows a recipient 108 at a forty-five-degree angle to the combustion chamber 101. Angling recipient 108 may allow for more surface area of the recipient to be covered by the vapor coming from the combustion chamber or for one area of recipient 108 to receive a thicker porous layer than another area.

It will be appreciated that CCVD is a highly versatile method of deposition. This versatility allows it to integrate with many forms of core formation without a significant increase in cost.

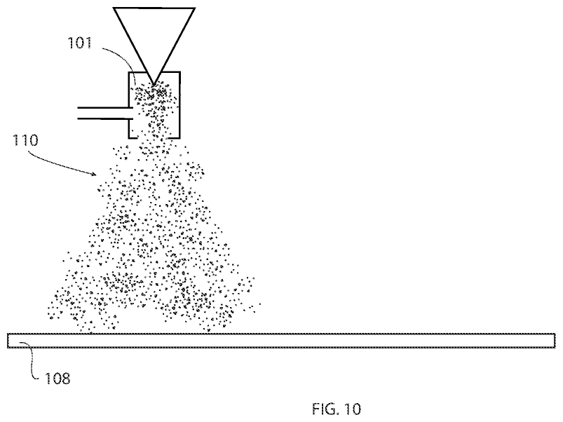

In at least one exemplary embodiment, the burner may move as it deposits the porous insulation layer. This may be useful for rapidly depositing insulation layers on multiple recipients or depositing on larger recipients. In the situation shown in FIG. 10 the vapor particulates 110 coming from the combustion chamber 101 do not fall over the entirety of the recipient 108 surfaces. Moving the combustion chamber 101 could allow the single burner to cover the entire recipient 108 surfaces with a deposit.

In at least one exemplary embodiment the recipient may move; this is one possible solution to the situation shown in FIG. 10. In FIG. 10 the recipient 108 may be moved so that each surface portion of the recipient 108 that should be covered may come in the range of the vapor 110. The recipient may move at a rate exceeding one meter per minute. The recipient may include the pattern from dry film patterning or photoresist patterning processes so that the dry film, for example, receives a portion of the insulation deposit. The dry film or photoresist is then easily removed using standard stripping techniques due to the porous nature of the insulative material which allows the stripping chemicals to reach the dry film or photoresist.

The movement of the burner or the recipient in at least one exemplary embodiment includes a rotational movement that allows the burner to more evenly coat a side or to coat multiple sides of the recipient.

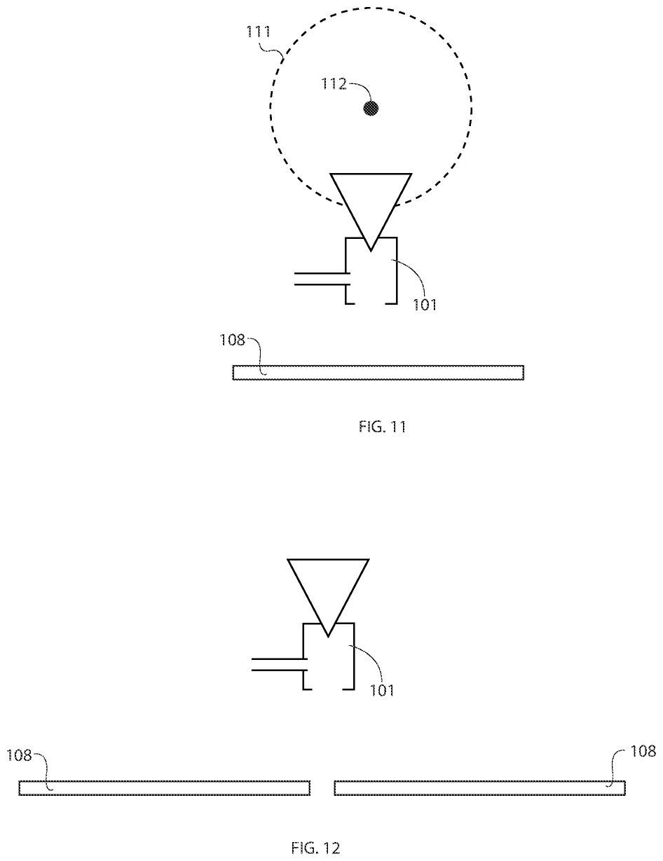

FIG. 11 shows a combustion chamber 101 that may rotate along path 111 around point 112. This can generate a tilting motion, and it may be useful for depositing on a single recipient that is larger than the area of deposition or depositing on multiple portions of a recipient 108 surface while leaving some portion of the surface uncovered.

It is also possible to utilize multiple recipients under a single burner as FIG. 12 shows a combustion chamber 101 placed over two recipient 108 which it coats, to coat the recipient 108 at different rates the combustion chamber 108 may have some filter to control the vapor flow to each of the recipients. The recipient 108 arrangement of FIG. 12 may occur if recipients are passed under a continuous vapor stream from the combustion chamber 101.

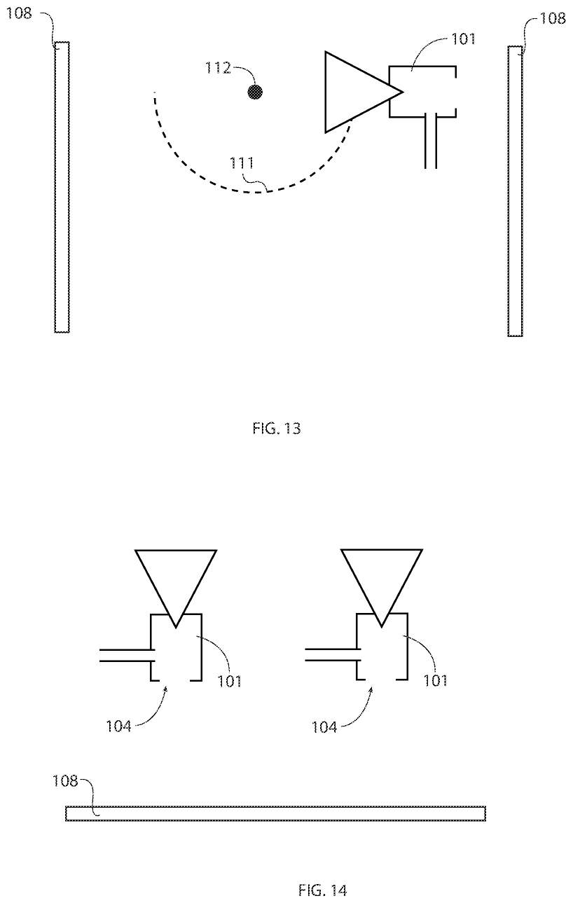

In at least one exemplary embodiment burners may move between recipients. FIG. 13 shows a combustion chamber 101 with a recipient 108 positioned to one side of the combustion chamber 101 and a second recipient 108 on the opposite of the combustion chamber 101. In this example, the combustion chamber 101 may rotate or move, for example along line 111 around point 112, so that it may coat both recipients 108.
b. Multiple burners may be used to plate a single recipient FIG. 14 shows two stationary combustion chambers 101 over a single recipient 108 this is one method of allowing more of the surface area of the recipient 108 to be coated at once. Other methods for depositing on multiple recipients include moving the recipient or combustion chambers, using a bigger combustion chamber, varying the nozzle 104 of the combustion chamber, the size of the combustion chamber, the distance of the combustion chamber from the recipient, or the properties of the combustion reaction occurring in the combustion chamber.

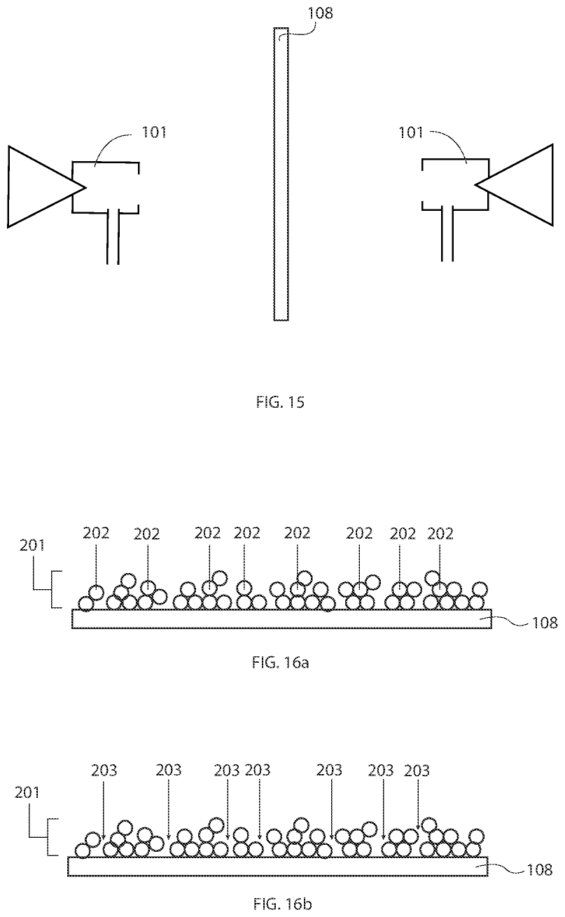

FIG. 15 shows two combustion chambers 101, the combustion chambers 101 are configured to each plate on a different side of the recipient 108. This demonstrates an example showing that with the use of multiple burners, multiple sides of a recipient 108 may be plated at once. Using multiple combustion chambers 101 helps prevent cornrowing which occurs when the area directly under a combustion chamber 101 receives more material than the other areas.

In at least one exemplary embodiment multiple burners may move. Movable burners may be used in conjunction with stationary burners. The recipient may move even with multiple burners.

There are several considerations related to the combustion reaction and layer formation to consider when placing a combustion chamber. These factors may be tuned to the placement of the combustion chamber, or the combustion chamber may be placed to fulfill a predetermined set of parameters. The parameters of CCVD all balance with each other so considering one may require tweaking the other.

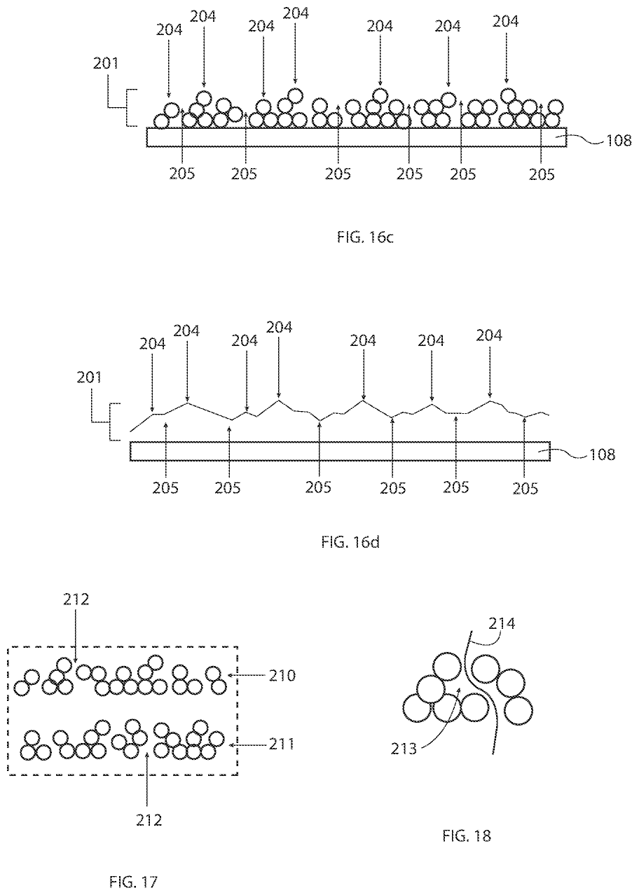

FIG. 16a and FIG. 16b show a CCVD product layer 201 plated onto a recipient forming molecule clumps 202. This particulate nature also holds true for AP-PECVD deposition. The product 201 layer is made of particulates 202. This product layer 201 gives an example of the random distribution of the porous particulate layer from a CCVD process. It is important to note that certain voids 203 are created between the molecule clumps 202 that leave portions of the recipient 108 exposed. It is nearly impossible to eradicate or fill all voids 203 by continuing to deposit product by CCVD given the random distribution and nano-scale size of the molecule clumps falling or being ejected from the combustion chamber.

Thus, when CCVD is used to form a layer, the layer has some voids which leave a percentage of the recipient surface uncovered. This is an intrinsic property of CCVD product layers and the use of CCVD in this present invention intends to, and does, utilize this property of the product layers formed by CCVD.

The voids of FIG. 16b are non-limiting examples of randomly formed voids (demonstrating that in fact, the voids can take a variety of shapes). The voids can come in any shape the CCVD product can form in three dimensions, and every time a CCVD product layer is formed, the voids will be randomized in both shape and location. It will again be appreciated that the use of CCVD in this invention is for the purpose of cheaply achieving product layers with these voids.

The product layers of CCVD may be thin and rough as well. As the combustion products fall like molecular snow onto the recipient it is simple to get a layer that is very thin—even down to single molecules in some areas, by reducing the time of deposition.

Given that the molecules randomly distribute, the molecules and clumps will present a rough surface full of peaks 205 and valleys 206 as shown in FIG. 16c where the peaks are clumps of molecules and FIG. 16d which gives a linear approximation of the same molecule clumps to show peaks and valleys more clearly. This current invention realizes that this roughness can provide a mechanical bonding means with a subsequent layer in an electroplating process. It is further counterintuitive to use rough layers because it introduces inefficiencies such as longer paths for magnetic flux. However, the benefits here outweigh the downsides of a potentially increased flux path length.

CCVD, therefore can be used to generate thin, rough, porous layers through voids on the surface of the recipient. Any form or modification to the CCVD process that still results in the voids in the porous product layers may be utilized in the present invention. There exist modifications to the CCVD process such as r-CCVD which are still suitable for the purpose of the invention. However, the use of CCVD with a Pryosil precursor is a cheap, effective, and easily available method of generating a useful porous insulation layer.

The present invention allows inductors and transformers to be built at ½ to ¼th of the thickness of current discrete inductor solutions for a similar performance and cost as the electronic component thickness is determined by the B_{SAT} of the magnetic core. The end product inductor and transformers may then be integrated into smartphones, tablets, notebooks, earbuds, IoT devices, and all devices that use passive magnetic components thus allowing designers to produce thinner consumer products or reduce the price of these products through simplified industrial design.

A randomly formed porous layer pushes the boundaries of what is possible in core design by having voids that leave some portion of the underlying recipient uncovered, as shown by FIG. 14a for example. The amount of the underlying recipient that is covered by the SiO₂ is called the coverage percentage. A porous layer may be a solid insulation layer intentionally designed to have an arrangement of voids or defects in its coverage of the underlying layer or it may be a randomly generated particulate layer.

The voids through the porous layer allow for the underlying and overlying magnetic material layers to bond with each other. Therefore, the simple steps of CCVD onto a recipient followed by the plating of a subsequent core layer will allow the layers to interact and bond with each other if the two layers would ordinarily bond or otherwise interact with each other. In at least one exemplary embodiment of the present invention, there are no special steps required between the plating of the porous layer and the magnetic materials. Therefore, you can plate a magnetic material layer, wash and dry the surface, then deposit an insulation layer, and immediately electroplate another magnetic material layer without even lifting the original core patterning (e.g., original photo resist or dry film) to produce a patterned hybrid material.

In addition to the cost savings associated with a reduction in patterning mask steps, a single masking step provides the patterned hybrid materials with straight edges because the pattern which defines the edge of a material is never replaced and thus avoids any micro-shifting from pattern replacements and alignment tolerances. The straight edges hold true for other patterning processes in additive manufacturing, including photo resists. The ability to keep a straight edge removes a large source of reliability issues as compared to other laminated cores which require the resetting of patterns. Typically, one new pattern is required to form every new layer, and thus are subject to layer misalignments, less magnetic material as the layering continues, adhesion issues, and excessive process material and chemical waste in a much more energy intensive process.

The CCVD-formed insulation layers and electroplated magnetic layers perform and are simulated as a new material with its own unique conductivity, skin effect, B-H curve, and B_{SAT} parameters instead of a material true laminated core where each layer is heavily or wholly isolated from the others. These unique properties vary by the layering thickness and as such new magnetic material variations can easily be designed for frequency response, magnetic permeability, and peak magnetic saturation as required for the end application.

The CCVD-generated porous layer can be integrated into any magnetic material that is electroplatable. In most cases, a recipient is plated, the porous layer deposited, and a subsequent layer deposited. However, the CCVD porous layer may also form an initial layer or a final layer which in many cases is beneficial for adhesion.

The magnetic material can be formed into a magnetic core of any type, form, or shape. Typically, a magnetic core will be a single material such as a nickel-iron; however, to add other properties, for example, to control thermal expansion or increase the resistivity of the insulation layer, combinations of materials such as Ni 36%, Fe 64%, including non-magnetic materials such as NiP, may be used within the core. The CCVD and AP-PECVD processes described in this invention are still able to produce an insulation layer for cores that include materials that are not magnetic in combination with magnetic materials.

CCVD may also be used to form insulation layers in conjunction with other insulation forming methods; this may allow CCVD hybrid materials to serve themselves as layers in a traditional layered core. The elegance of CCVD allows for the low-cost implementation of CCVD into almost any electroplating methodology, including DC plating, Pulse Plating, Reverse Pulse Plating or a combination of these methods.

In at least one exemplary embodiment, a core utilizes a SiO₂ porous layer. FIG. 14a shows a porous layer 202. The SiO₂ particulates themselves have insulative properties, but the layer is not solid, as can be seen in FIG. 14b as the SiO₂ layer 202 has SiO₂ voids 203. Although the ability to prevent eddy currents is reduced when compared to a solid layer of SiO₂.

Yet, the voids are typically offset when multiple porous layers are used. Given the small size of the voids it is unlikely that random voids will overlap. This is shown in FIG. 17 where two porous layers are shown, porous layer 210 and porous layer 211, and each porous layer has at least one gap 212 that is offset from the voids of the other layer. So, although in one layer there is a gap that does not provide an insulative effect, at the next layer there is insulation, thus increasing the edge current path length which increases the resistivity which in turn reduces the eddy current. Further, the voids themselves are not by necessity linear, and an example of a crooked gap is shown in FIG. 18 where gap 213 is a nonlinear through gap such that to avoid the insulation layer a winding pathing 214 would be required.

The offset voids when a first layer is created with at least one additional layer mean that the pathways that eddy currents could take through the layers provide some resistance compared to a linear pathway. The fact that the voids may also be non-linear has the effect of reducing the eddy current slightly as well. The use of SiO₂ allows for a robust insulation layer even when thin and porous. In non-particulate porous insulation layers which have or may have systematically formed voids, for example, printed porous insulation layers, the voids may be purposely offset from each other.

FIG. 19 shows three porous insulation layers: layer 215, layer 216, and layer 217. An eddy current 218 runs through the insulation layers and is reduced in strength by each of the insulation layers that it passes through.

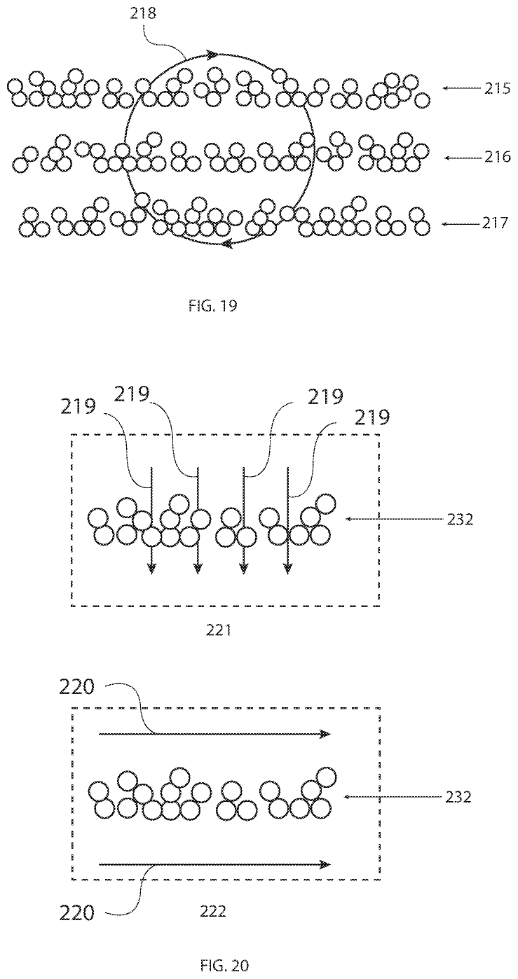

Eddy current runs perpendicular to magnetic flux lines. FIG. 20 shows two blocks with insulation layers, block 221 and block 222. Each block has the same porous insulation layer 232 and block 221 has vertical pathway lines 219 while block 222 has horizontal pathway lines 220. Lines 220 in block 222 do not cross insulation layer 232. However, lines 219 in block 221 represent the perpendicular pathway that an eddy current magnetic flux would take if magnetic flux lines followed the lines of block 222. Thus, it can be seen that these porous layers give an insulative effect that only limits the pathways directionally. Given that the material into which a porous layer has been plated takes the properties of a new material and essentially becomes a new material, it can be said to become a material with directional impedance.

The more insulation layers an eddy current path would cross, the weaker the realized eddy current. Each insulation layer adds resistance against eddy currents; therefore, finer layering increases the frequency response of the magnetic material as the eddy current must cross an insulative boundary.

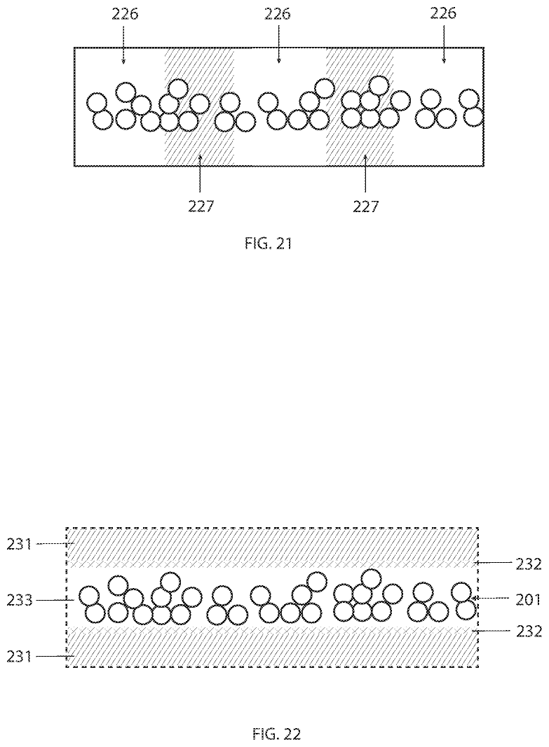

Each layer that is placed down may comprise several materials. The layer may be a homogenous mix of materials, or it may have a heterogeneous arrangement. A homogeneous mix of materials is a mix of materials where each material is evenly distributed throughout the layer. A heterogeneous mix of materials is a mix of materials where the material is distinctly defined within the layer, for example, in FIG. 21 where a first material 226 distinctly alternates with a second material 227. Given the nature of porous layers, as long as the recipient and subsequent layer will plate with each other, the layers can be plated through a porous layer, and as long as the layers are useful for forming a magnetic core, the layers may be used in a hybrid material mass.

The hybrid material may have multiple metal layers before a porous insulation layer. For example, FIG. 22 shows a hybrid material having a porous insulation layer 201, magnetic layers 231, 232, and 233 where 231 is a first metal, 232 a second metal, and 233 a third metal. Any arrangement of magnetic layers is possible. FIG. 21 shows a metal layer 233 which is for the purpose of filling the voids of insulation layer 201 and does not exceed the boundaries of insulation layer 201.

With SiO₂ as a porous layer, when electroplating, the material that is being deposited will only plate onto the material of the recipient and not the SiO₂, which is effectively inert in an electroplating bath. Therefore, the electroplating layer will start in the voids of the porous layer where the recipient is exposed. The electroplated layer will build up until the porous layer is filled with the electroplated layer, and then the electroplating layer will build out the subsequent layer encapsulating the particulates. Therefore, the voids of the porous layer do not become air voids but are instead filled with the plated material, as shown in FIG. 1B.

Once plated, the porous layers enhance bonding with the subsequent layers by mechanical means. The porous layers are rough, having peaks and valleys as shown in FIGS. 16c and 16d; this rough surface provides a means of mechanical bonding by entangling the porous layer with the subsequent layer—strengthening the material. The pattern of the porous layer is random, and therefore the entanglement is random. Mechanical bonding provides increased protection against shear forces.

The strength of the hybrid material is also increased over true laminated cores because the two layers around the porous layer will bond to each other and thus become like one layer of material. A true laminated core will have separated magnetic layers so that the magnetic layers must rely on the strength of their bond with their adjacent smooth insulation layers to resist separating forces. Since with the porous layer, hybrid core layers are connected, the hybrid core is stronger against mechanical stress than a laminated core with smooth insulation and unconnected magnetic layers.

With porous particulate insulation layers nature of the particulates makes it practical to drill or etch or undermine and sweep away with any number of layers. Silicon dioxide as a solid layer is not conducive to subtractive manufacturing processes and is quite chemically inert and is commonly removed with Hydrofluoric acid “HF” which is an extremely dangerous chemical requiring specialized equipment, training and personal protection. SiO₂ has a hardness of 7 on the Mohs scale for minerals, which goes up to 10. As such, SiO₂ itself is resistant to many tools commonly used to manipulate or refine magnetic cores. So, when in a solid non-porous layer, it is too strong to be practically manipulated with classic drilling or etching processes. However, CCVD deposits the silicon dioxide as groupings of particulates that are loosely connected to each other and have voids that allow the non-porous insulative layers to cross through the porous layer. As hinted by the discussion of pulse plating, in porous form, the particulates of SiO₂ will come loose with whatever layer they were deposited on.

In a drilling process, the SiO₂ layer particulates will be moved by the force of the drill as the SiO₂ particulates are not bonded to each other and do not present much resistance to any drill that can drill through the material around the porous layer. Although the particulates themselves are tough and would be hard to drill through—they will leave the magnetic layer just like any other drill dust from that layer.

In an etch process, for example, a wet etch, a pattern is formed on the material to be etched. A chemical is then poured onto the material, and it will etch the material according to the pattern. Etching Silicon Dioxide, when it is in a solid non-porous layer form, requires its own set of strong chemicals and considerations separate from the materials which may surround it. However, in a CCVD porous-based material, whatever chemical can etch the materials around the SiO₂ layer will be able to remove the particulates of the insulation layer. As the etching process will be able to remove everything around the particulates of the porous layer so that the particulates are free from the material and will get washed out even if the SiO₂ particulates will themselves not react with the acid.

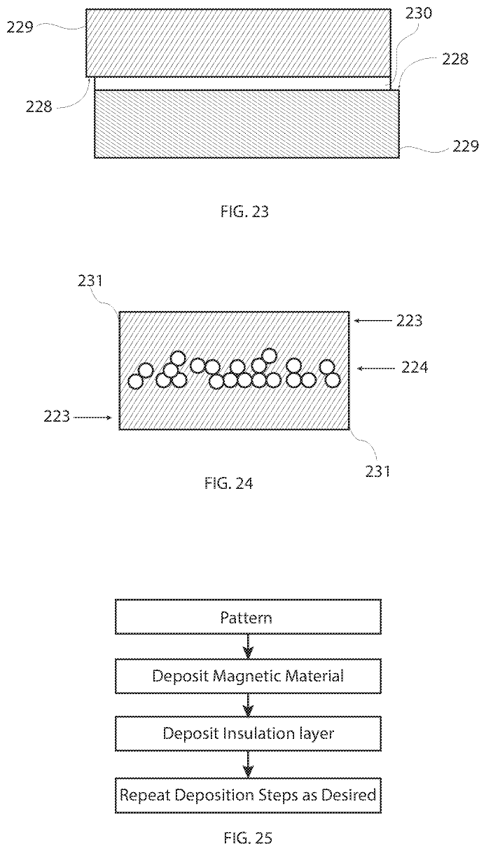

The ability to perform subtractive manufacturing processes in a practical and low-cost method opens the door for new magnetic core designs to be used. The porous layers are easy to place and work with. For example, in cases of electroplating when a film is used, where, as noted above, there is no need to replace the dry film when using CCVD given the ability to through-plate through the porous layer. The dry film does not need to be removed even if the CCVD burner will deposit the product on the dry film. Thus, with CCVD, you can have a single burner depositing a porous layer on the entire wafer. As insulative layers for hybrid cores themselves do not serve as electrodes the electroplated layers will not form on the SiO₂. Thus, the presence of SiO₂ or other insulator on the dry film does not affect the electroplating steps. When the dry film is removed, the particulates on the dry film will be removed as well.
c. A true laminated core layer will require replacing the dry film between the formation of each insulation layer. Alignment tolerances in replacing a dry film pattern will often result in misaligned sidewalls. FIG. 23 shows a true laminated core having a magnetic layer 229 and insulation layer 230. The replacement of the dry film has left an offset 228 between each of the laminated layers.

A hybrid magnetic core will present a smooth edge 231, as shown in FIG. 24. Here, magnetic core layers 223 were built using the same dry film pattern. Therefore, edges 231 are not offset but stay smooth for the entire core height for as long as a single dry film layer or pattern is used. A hybrid core built by dry film patterning will have a core wall smoothness that matches the smoothness of the dry film used.

This invention incorporates many methods of electroplating including DC plating, pulse plating, reverse pulse plating, and jet electroplating or any combination of these plating methods. It is an elegant solution to adding an insulative layer without adding significant extra steps and, in general, will require far fewer steps than a true laminated core. Laminated components, in general, require multiple steps to switch between the formation of one layer and the next type or material. This magnetic material and CCVD insulation process is as simple as 1. plating a layer in a bath, pulling it out, 2. washing, 3. drying, and 4. depositing the insulative layer onto it. Thin-film magnetic laminated materials or cores can be realized in four steps as opposed to thirteen or fourteen, which are the general industry practice known at the time of writing.

In at least one exemplary embodiment the voids in the insulation layer regardless of method of producing the insulation layer are such that the voids are individually between 10 nm and 5 μm, the insulation leaves 3 to 5 percent of the underlying metallic layer exposed however exposures of 15% to 0.01% have been found to have economic value. However, voids of up to 22 μm in width can be statistically acceptable if the prevalence is low.

The CCVD or AP-PECVD hybrid material of the present invention behaves as if it is a single material in terms of plating and elegantly integrates into magnetic core plating processes. However, there are many suboptimal processes which may take advantage of one or more of the key inventions that make up the novel magnetic material process. To those trained in the art various suboptimal methods of introducing voids in insulation result in a reduction of layering patterns for example with electrostatic discharge, radiation, laser, grinding, or polishing produce to voids 22 μm or smaller at an relatively even density in a regular or random fashion or any other insulation deposition method or post-insulation deposition method that is designed to introduce the necessary voids, porosity, or gaps necessary to immediately begin electroplating following the insulative deposition including by thinning a deposited nonporous insulation layer is covered by this invention.

FIG. 25 is a flowchart of the plating steps, in at least one exemplary embodiment of the present invention, in what is essentially a two-step repeatable process not including washing and drying. The hybrid material is either patterned or not depending on the application. The second step is to deposit metallic metal on the first recipient which is followed by the deposition of the porous layer. The deposition of the recipient and porous layer steps may be repeated in order as desired.

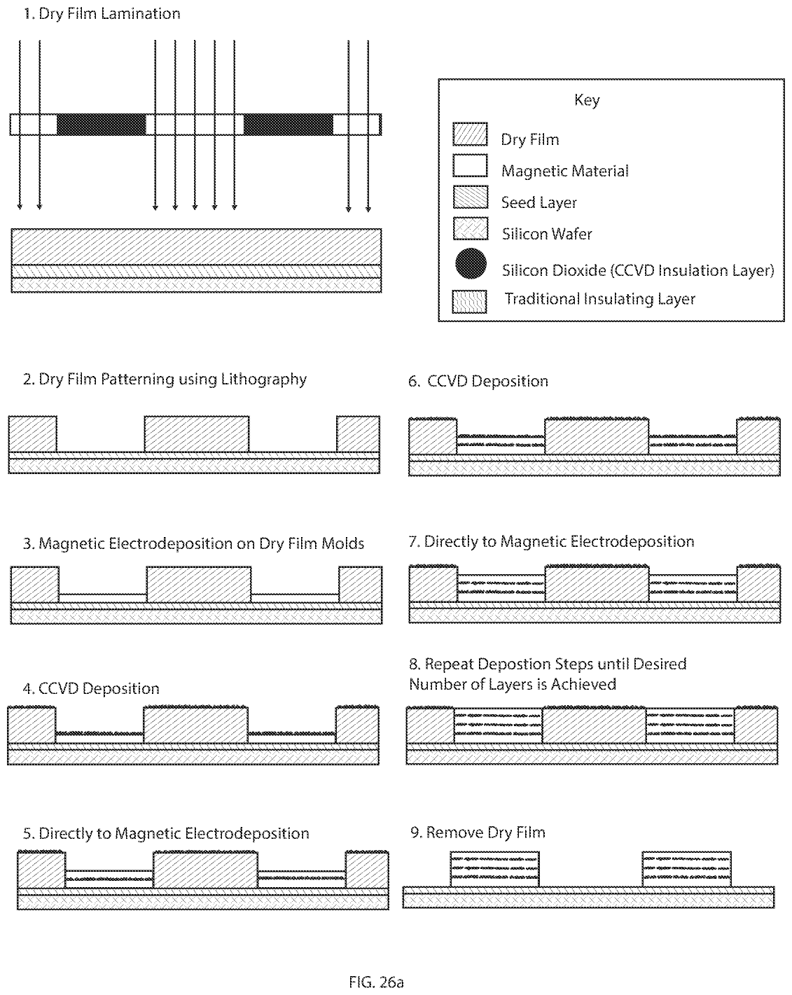

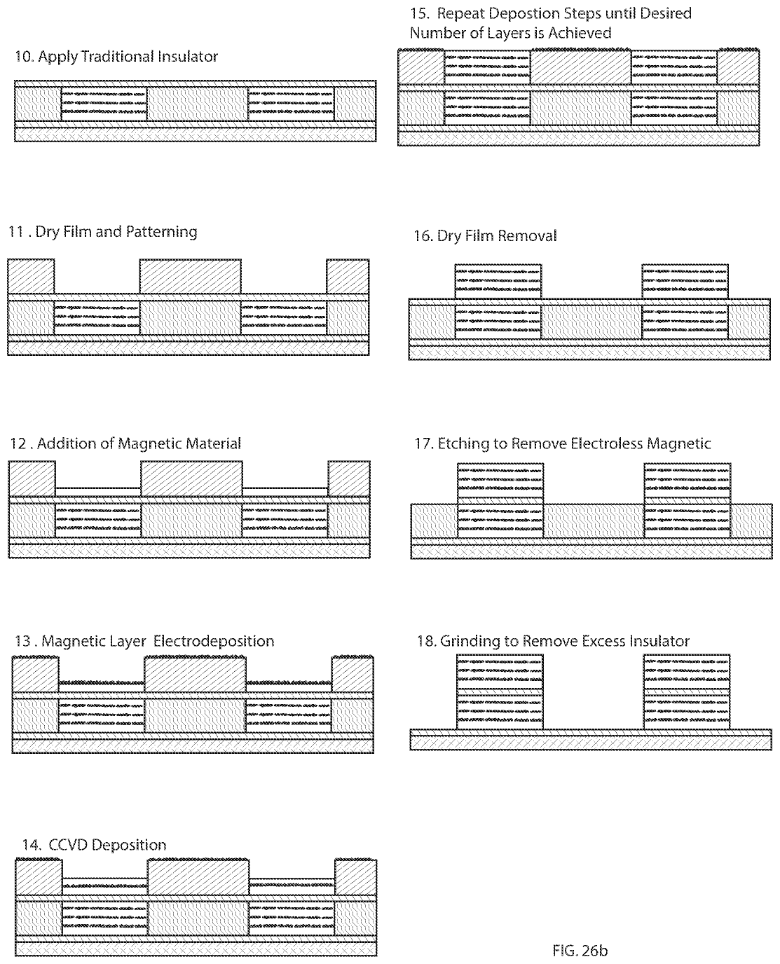

FIG. 26a provides an example of how each step of FIG. 25 plays out in the formation of a hybrid core by CCVD. Step one shows the dry film patterning to form a core. In at least one exemplary embodiment, as shown in FIG. 26a, more than one core can be patterned at a time. Step two shows that the layer has been patterned. Step three shows the first magnetic layer having been deposited. Step four shows the CCVD process has been used to plate a porous insulation layer. The insulation layer is deposited on both the dry film and the recipient. Step five shows a subsequent magnetic core layer is then plated onto the porous layer. Step six shows the deposition of the porous layer. Step seven shows the plating of a magnetic layer. Step eight shows a potential end result of repeating the recipient deposition and the insulation deposition steps. Step nine shows the step of removing the dry film.

FIG. 26b, shows an additional process that may be performed after the height of the dry film is reached or if the magnetic core shall be a hybrid core with a true lamination layer integrated within. Step ten shows the placement of a traditional insulator and seed layer to provide a flat surface to build the subsequent core layers. Step elven shows a new patterned dry film. Step twelve shows the deposition of the first magnetic core layer. Step twelve shows the deposition of the porous layer. Step thirteen shows a potential end result of repeating the recipient deposition and the insulation deposition steps. Step fourteen shows the removal of dry film. Step fifteen shows the etching to remove the seed layer. Step eighteen shows the result of a grinding step to remove excess insulators.

Because the electroplated core with CCVD porous insulation layer is built up layer by layer, air voids and other modifications can be added to the core by building up the layers according to the relevant patterning process, for example, an air-gapped core pattern for an air-gapped core.

Because there is no need for special intermediary steps for the formation of the porous layer, such as preparing the recipient for receiving the porous layer or re-patterning for the porous layer, the CCVD process can be integrated into many pre-existing plating processes without limiting the shapes that the plating processes can produce. There are many shapes of cores, toroid; solenoids; EE, EI, L, and LI transformer shapes; and circular, elliptical, square spirals are just some examples. The present invention may be incorporated into the manufacturing process of each of these core shapes or any other plateable core shape.

It is not necessary to exclude true laminated insulation layers from cores that also have porous layers. Therefore, in at least one exemplary embodiment, a magnetic core is a hybrid magnetic core that is built with at least one traditional insulation layer as well as at least one porous insulation layer. Multiple cores can be stacked by applying a traditional insulator layer onto the top of a hybrid magnetic core. One example starts with a first layer of an electroless copper electrode placement then all other layers are CCVD magnetic cores, but when the hybrid cores start to approach the upper limit of the patterning dry film (for example, at 50 μm), the process may stop and a traditional insulation layer applied, the surface prepped, e′less copper deposited, new dry film applied. Once the new dry film is applied and patterned, the process again returns to the CCVD method to build the next 50 μm of the core. This process may be repeated as desired. There is no theoretical limit to the number of stacked cores.

Once a hybrid core or stack of cores has been made, it can be incorporated into a device, for example, an inductor used in the microelectronic industry. In at least exemplary embodiment, this may be achieved by depositing or forming the hybrid material mass in the shape of a core on a silicon wafer, electroplating a conductor in a coil around the core, and placing an insulation layer around the core. In at least one embodiment, the base silicon wafer may be replaced with an epoxy plastic and between core insulation layers may be epoxy-based build-up film, fully insulating SiO2, parylene, polysiloxane, Teflon, PCB varnish, similar industrially available insulators, or other insulators.

In at least one exemplary embodiment, the electroplated wire may be a conductor such as copper, aluminum, or other conductive metal or an alloy thereof. The conductor may be deposited by an independent process.

In at least one exemplary embodiment, the magnetic layer is nickel-iron. In at least one exemplary embodiment, multiple nickel-iron layers are placed before a porous layer is placed. In at least one exemplary embodiment, multiple nickel-iron layers are placed before a porous layer is placed, a subsequent nickel-iron layer is placed, an ABF film layer is placed, and multiple nickel-iron layers are then placed before a porous layer which is then followed by another porous layer. Each of these layer arrangements may be made into a complete core, and a subsequent core plated above it. Other core layers materials include but are not limited to, Ni, Fe, Co, NiFe, CoNiFe, CoNi, CoFe, and various alloys of these elements. The elements chromium, magnesium, aluminum, phosphorus, or sulfur are a non-exhaustive list of additives that may be used to alter mechanical, electrical, or magnetic properties of Ni, Fe, Co, NiFe, CoNiFe, CoNi, CoFe, or the core in general for example, by providing protection against damage from materials having mismatched coefficients of thermal expansion. The additives may be added to a single layer or mixed in with other materials. In the present invention, additives can serve as the metal which fills the insulative layer.

Multiple embodiments are built on the steps of, with regards to method, The plating of a layered magnetic core, comprising preparing a magnetic core layer; generating an insulating porous material; coating a first surface of the magnetic core layer with the insulating material to form a first insulating layer; and plating onto the exposed surface of the insulating layer a second magnetic layer. In at least one exemplary embodiment, this process may be repeated to form a single core.

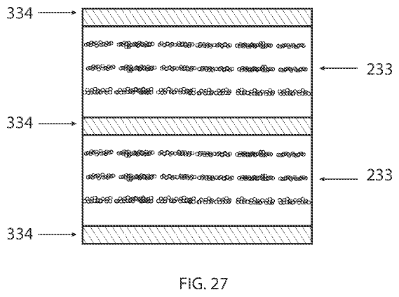

FIG. 27 shows a stack of hybrid cores 233 with nonporous insulation 234. In a stack of magnetic cores, the nonporous insulation material may be semiconductor build-up film “ABF” or equivalent or another highly insulative material designed to electrically isolate each magnetic material in the stack to achieve a total magnetic material thickness of up to 4 mm. For example, 60 layers of 0.5 μm NiFe/0.05 μm SiO2 may be separated from another 60 layers of 0.5 μm NiFe/0.05 μm SiO2 by 25 μm of an epoxy layer and this may be repeated at least once.

The magnetic cores of a stack may also be offset, and there may be more than one core per layer. A stack of hybrid cores may be shaped and used as a single laminated core. To form a magnetic core the hybrid material is shaped as a core, having the necessary dimensions to serve as a core. The shaping of the core may be additive or subtractive, for subtractive processes the core or core stack is built up as a series of magnetic material masses and then shaped into a core. porous particulate insulation layers are especially suited for subtractive processes because, as mentioned above, they remove the special considerations which must be given to insulative layers during subtractive processes.

In embodiments where the hybrid material is shaped as a magnetic core whether that shaping incorporates a stack of cores or a single core, wire can be plated around the core, or in the case of multiple cores, plated between or around the cores. Plating wire between or around the cores is a low-cost method of incorporating the cores into larger components including inductors.

Once formed, the CCVD layer creates a core with desirable electrical and magnetic properties. Experimentation has shown that these properties are dependent on layer thickness. For example, an experiment was run with several cores, each having a different thickness. In these cases, the layer thickness refers to the thickness of the metal layers. The hybrid first core was 18 μm thick, and each layer had a thickness itself of 2.1 μm. A second hybrid core was 60 μm thick, and each layer had a thickness itself of 4 μm. A third hybrid core was 60 μm thick, and each layer had a thickness itself of 0.3 μm. A pure magnetic material core and an air core were used as control.

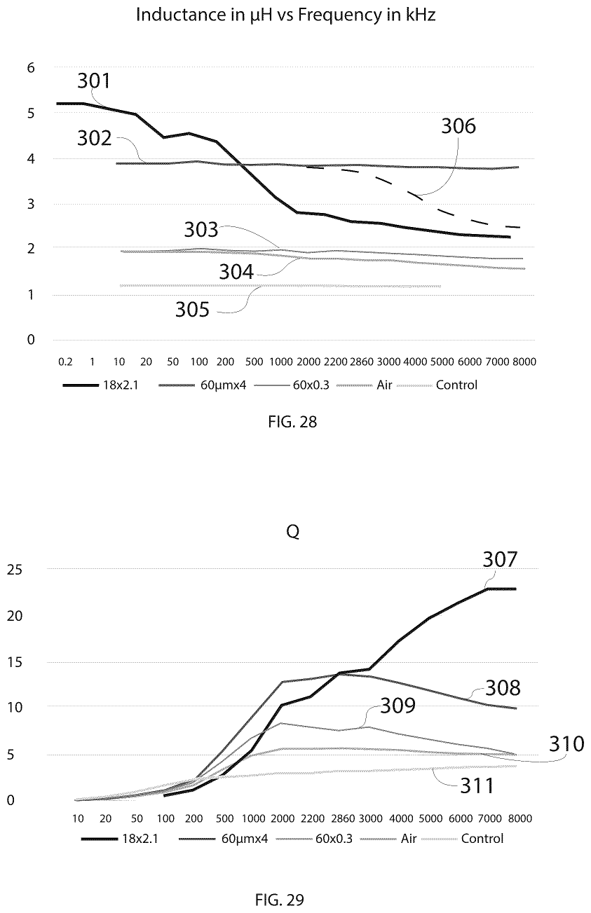

From the experiment, the graph shown in FIG. 28 demonstrates the relationship between inductance and frequency at different layer thicknesses. Line 301 is a hybrid core with 4 μm per layer thickness. Line 301 shows a significant inductance reduction after 500 kHz. Line 303 is the hybrid core with a 2.1 μm per layer thickness showing a significant inductance reduction at 2 MHz. Line 302 is the hybrid core with a 0.3 μm per layer thickness showing a significant inductance reduction only beyond 8000 MHz. Control line 304 is an uninsulated magnetic core, and control line 305 is an inductor with an air core.

Line 302 has the same number of layers as line 301; however, the layer thickness of line 302 is thinner than line 301. The thinner layers are better at handling eddy currents at high frequencies. The downside to line 302 is that in low frequencies, it does not start with as high of inductance as line 301. This demonstrates a balancing act: by decreasing layer thickness, inductance remains stable over a wide range of frequencies, but it does not go as high as it would for a thicker layered hybrid core. Therefore, hybrid core design may be balanced according to the frequency and inductor needs of the component's applications.

In at least one exemplary embodiment of a nickel-iron core, the conductive layer is 0.1 to 1.50 micrometers. At least one other exemplary embodiment may have any thickness between 0.05 and 3 micrometers. At least one exemplary embodiment may have any layer thickness. However, ranges in the 0.05 to 3 micrometer range are expected to have economic merit in the microelectronic industry depending on the traits desired for the new CCVD material.

Line 302, a hybrid core with a layer thickness of 0.3 μm, does not suffer a significant drop in inductance until 8000 hertz. This is vastly different from the pure laminated magnetic core, which may produce line 306. Line 306 shows the expected drop in inductance without porous insulation layer for a 60 μm total thickness laminated magnetic core, to be compared to line 302, which is representing a 60 μm total thickness hybrid core with CCVD SiO₂ deposited every 0.3 μm.

The graph shown in FIG. 29 shows the quality factor over frequency for an inductor. Line 307 is an air core. Line 308 is a hybrid core with a 0.3 μm per layer thickness, line 309 is the hybrid core with a 2.1 μm per layer thickness. Line 310 is the hybrid core with a 4 μm per layer thickness. Control line 310 is an un-insulated magnetic core, and control line 311 is an inductor with an air core.

A quality factor of over ten is highly desirable. This level of quality factor is best achieved by hybrid cores having a conductive layer thickness of 1 to 1.50 micrometers; cores with this layer thickness achieve the quality factor of ten at lower frequencies than air, while it appears other hybrid core thicknesses struggle to reach a quality factor of even eight. Line 103 has a conductive layer thickness of 0.3 micrometers.

The flexibility in the design and shaping of the hybrid core with a lithographic process enables a wide array of shapes and sizes of cores to be made. Possible shapes include but are not limited to toroids, solenoids, EE, EI, L, LI transformer shapes, circular, elliptical, square, and spirals. This flexibility allows the cores of the present invention to integrate into an extremely large range of magnetic components allowing the components to realize the performance benefits of a porous layer.

Given the adaptability of the manufacturing of the hybrid cores of the present invention they can be integrated into a wide variety of inductors and the components and circuits which rely on them including power supplies, filters, transformers, oscillators, and sensors. The inductor itself is not limited to having a full hybrid core but may have a core that utilizes porous and true insulation layers or multiple cores where at least one core is a hybrid core. The elegance of the hybrid core manufacturing process means that it does not prevent a barrier to forming the hybrid core in-package. The hybrid cores, therefore, are suitable for both discrete components and in-package inductors.

Other devices incorporating magnetic cores or magnetic materials such as coupled inductors, read heads, motors, and signal isolation coils may have cores made in full or in part from the CCVD magnetic core process as described above. In fact, a nearly unlimited variety of magnetic components with a core may have a hybrid core of the present invention.

The hybrid core with a porous layer provides metal cores the ability to achieve closer to ideal magnetic properties as it reduces hysteresis loss and eddy current loss. This increase in efficiency for the hybrid cores allows metals to be used in cores as a practical solution for small consumer electronics which can take advantage of the core size reduction or the increase in frequency handling capabilities.

To place a core in a system, a core is typically designed to achieve the properties desired for that system. Therefore, cores may be designed from the ground up for a system or a system type.

Some embodiments and/or implementations include one or more hybrid core based inductors used in a DC/DC application in buck, boost, or buck/boost configurations. One or more hybrid core inductors or transformers are used in DC/DC or AC/DC applications. One or more hybrid core inductors or transformers are used for signal isolation circuits. The use of a hybrid magnetic material for the purpose of proximity sensing is optimized for wireless battery charging. One or more hybrid materials or cores are used in a smartphone, watch, tablet/pad, or notebook computer for the purpose of power distribution; proximity sensing; signal isolation; battery charging either direct charge or wirelessly.

The present invention enables small low-cost high frequency capable magnetic cores. By providing low cost and high frequency cores, the present invention enables many practical electronics.

The drawings and figures show multiple embodiments and are intended to be descriptive of particular embodiments but not limited with regard to the scope or number, or style of the embodiments of the invention. The invention may incorporate a myriad of styles and particular embodiments. All figures are prototypes and rough drawings: the final products may be refined by one of ordinary skill in the art. Nothing should be construed as critical or essential unless explicitly described as such. Also, the articles “a” and “an” may be understood as “one or more.” Where only one item is intended, the term “one” or other similar language is used. Also, the terms “has,” “have,” “having,” or the like are intended to be open-ended terms. In any such item incorporated by reference in any section of the provisional patent application where there is a definition contradictory to the definition laid out in the provisional patent application in material fully integrated into the application, the definition that is fully integrated into the text of the patent will control the meaning for the present invention.

1. A magnetic mass comprising; at least one magnetic material having a porous insulative layer on an external surface of the magnetic material, the magnetic material capable of serving as an electrode in a plating bath.

2. A hybrid magnetic material comprising, at least one magnetic material having at least one internal porous insulative layer; and wherein, at least one of the magnetic materials fills the voids of the internal porous insulative layer.

3. The hybrid magnetic material of claim 2, wherein the hybrid magnetic material has side walls which do not have an offset portion.

4. The hybrid magnetic material of claim 2, wherein at least one internal porous insulative layer marks the boundary between different magnetic materials.

5. The hybrid magnetic material of claim 2, wherein at least one internal porous insulative layer marks the boundary between different magnetic materials of different thicknesses.

6. The hybrid magnetic material of claim 2, wherein the porosity of the porous insulative layer is defined by a series of voids in the insulation layer, with each of the voids individually smaller than 22 μm in diameter.

7. The hybrid magnetic material of claim 2, wherein the insulation layer has a coverage percentage between 90 and 99.99% and has a thickness of between 10 nm and 5 μm.

8. The hybrid magnetic material of claim 2, further comparing the hybrid material operably connected to a base.

9. The hybrid magnetic material of claim 2, wherein the magnetic material has a primary composition incorporating nickel, iron, cobalt, or an alloy thereof.

10. The hybrid magnetic material of claim 2, further comprising the magnetic material has a composition that incorporates a core additive.

11. The hybrid magnetic material of claim 4, wherein the magnetic material filling the voids of the porous insulative layer is a non-magnetic metal.

12. The hybrid magnetic material of claim 2, further comprises the hybrid magnetic material operably configured as a hybrid core.

13. The hybrid magnetic material of claim 12, further comprising a second hybrid magnetic material operably configured as a magnetic core, and metallic coil operably placed between the first hybrid magnetic material and the second hybrid magnetic material.

14. The hybrid magnetic material of claim 12, further comprising a metallic coil operably placed around the hybrid magnetic material.

15. The hybrid magnetic material of claim 2, wherein the base has a series of ridges of squared, circular, or triangular shapes with a localized roughness of less than 5 μm.

16. The hybrid magnetic material of claim 15, wherein the hybrid magnetic material is configured as a core and integrated into a stack of cores, operably connected to a base shared with the first stack of cores, each of the cores in the stack of cores are operably separated by an insulative layer, and the stack of cores having a total thickness of less than or equal to four millimeters.

17. The hybrid magnetic material of claim 16, wherein the insulative layer between each core of the stack of cores has greater than ten times the resistivity of the porous insulation layers within each hybrid material.

18. The hybrid magnetic material of claim 16, wherein the stack of cores is shaped and configured as a single magnetic core.

19. The hybrid magnetic material of claim 16 further comprising a metallic coil operably placed around the stack of cores.

20. The hybrid magnetic material of claim 16, further comprising a second stack of magnetic material, integrating at least one hybrid magnetic material configured as a core, operable as a single magnetic core, operably connected to a base shared with the first stack of cores, and a metallic coil placed between the first stack of magnetic material and the second stack of magnetic material.

21. The hybrid magnetic material of claim 20, wherein a metallic coil is placed between two stacked magnetic materials or around the stacked magnetic material.

22. The method of forming a hybrid magnetic material, comprising:
Preparing a layer of magnetic material;
Forming a porous insulation layer onto a surface of the layer of magnetic material; and
Depositing an additional layer of magnetic material onto a surface of the insulation layer in a manner connecting the additional layer of magnetic material to the prepared magnetic material through the porous insulative layer.

23. The method of claim 22, wherein the magnetic material has a primary composition incorporating nickel, iron, cobalt, or an alloy thereof.

24. The method of claim 22, wherein the magnetic material has a composition that incorporates a magnetic material additive.

25. The method of claim 22, wherein the deposition of a subsequent magnetic material layer immediately follows the insulative layer deposition with no surface preparation of the insulative material.

26. The method of claim 22, wherein a CCVD process is used to form a porous insulation layer porous silicon dioxide layer of less than 250 nm using any deposition angle, any number of burner openings, any combustion or precursor rate, any burner or magnetic surface movement or multiple depositions.

27. The method of claim 22, wherein an AP-PECVD process is used in the formation of the porous insulative material, using any deposition angle, any number of plasma sources, any chemical precursor rate, any plasma source or magnetic surface movement or multiple depositions; and the resulting porous insulation layer has a total thickness of less than 4 μm.

28. The method of claim 22, wherein the layering process occurs on both sides of a semiconductor substrate, semiconductor wafer, or printed circuit board simultaneously or serially.

29. The method of claim 22, wherein the formation of the porous insulation layer occurs by forming a nonporous insulation layer and processing the layer post deposition to introduce a regular or random pattern of voids in the nonporous insulation layer.

30. The method of claim 29, wherein the pattern of voids is produced by with thinning process of the nonporous insulation layer where the layer is thinned to such an extent as to introduce the necessary voids necessary to immediately begin electroplating.

31. The method of claim 22, further comprising performing and repeating at least once the steps of depositing an additional layer of porous insulation layer onto a surface of the additional layer of magnetic material and depositing at least one further layer of magnetic material onto the additional layer of porous insulation until or before the earliest of 60 core layers or 50 μm total magnetic material thickness is reached.

32. The method of claim 31, further comprising washing and drying each of the magnetic material layer before plating the additional porous insulation layer onto the magnetic material.

33. The method of claim 2, further comprising forming at least one magnetic material layer between the steps of preparing a layer of core material and forming a porous insulation material or between the steps of forming a porous insulation material and depositing an additional layer of core material or both.

34. The method of claim 33, wherein at least one magnetic layer has a composition which differs from at least one of the other magnetic layers.

35. The method of claim 22, wherein the method of preparing each magnetic material layer is an electroplating method.

36. The method of claim 35 wherein the electroplating method is a direct current plating, pulse plating, reverse pulse plating technique or a combination of these techniques.

37. The method of claim 22, further comprising depositing the hybrid material in the configuration of a magnetic core with use of a core pattern.

38. The method of claim 37, wherein the core pattern is not replaced or removed during the plating process and wherein the insulation deposition occurs in part on a top surface of the core pattern used in the deposition of the hybrid material for up to 60 electroplated magnetic layers.

39. The method of claim 37, wherein the core pattern is passed through a deposition flame or plasma at a rate exceeding 1 meter per minute.

40. The method of claim 37, wherein the core pattern is passed through a deposition flame or plasma at a distance closer than 20 cm from the source.

41. The method of claim 22, wherein the porous insulation layer is deposited by combustion chemical vapor deposition and is between 10 nm and 250 nm thick.

42. The method of claim 41, wherein a chemical precursor is a silicon dioxide precursor.

43. The method of claim 42, wherein the chemical precursor is a polysiloxane.
